(19) United States
(12) Patent Application Publication
(10) Pub. No.: US 2018/0243712 A1
(43) Pub. Date: Aug. 30, 2018

(54) PROCESS AND APPARATUS FOR SEPARATING PARTICLES OF A CERTAIN ORDER OF MAGNITUDE FROM A SUSPENSION

(71) Applicants: L'AIR LIQUIDE Société Anonyme pour I'Etude et I'Exploitation des Procédés Georges Claude, Paris (FR); The Petroleum Oil and Gas Corporation of South Africa (SOC) Ltd, Parow (ZA)

(72) Inventors: Manfred Ruppel, Dietzenbach (DE); Kim Scharf, Frankfurt am Main (DE); Uwe Eichmann, Frankfurt am Main (DE); Klaus Kirsten, Mainz (DE)

(21) Appl. No.: 15/758,176

(22) PCT Filed: Sep. 15, 2016
(86) PCT No.: PCT/EP2016/071863

§ 371 Date: Mar. 7, 2018

(30) Foreign Application Priority Data
Sep. 18, 2015 (EP) 15185912.1

(51) Int. Cl. B01J 8/00; B01J 8/22; B01J 38/72; B01D 21/24; B01D 21/00; B01D 21/34

(52) U.S. Cl. CPC B01J 8/007; B01J 8/22; B01D 21/34; B01D 21/2494; B01D 21/003; B01J 38/72

(57) ABSTRACT

The disclosure includes a process and a plant for separating a suspension C from a suspension A, wherein the fraction of particles P_{C} in the suspension C, which have a diameter smaller than a defined limit grain diameter, is greater than in the suspension A by at least the factor of 2. The suspension A is introduced into a container extending from the bottom to the top and a suspension B is withdrawn from the container, whose fraction of particles with a diameter greater than the defined limit grain diameter is increased with respect to suspension A. Due to the fact that suspension C is withdrawn from the container in a second partial stream above the first partial stream, in that the flow velocity of the suspension C is greater than the sinking velocity of the particles P_{C} contained therein, an effective separation can be achieved.

### CROSS-REFERENCE TO RELATED APPLICATIONS

This application is a national stage application under 35 U.S.C. 371 of International Patent Application Serial No. PCT/EP2016/071863, entitled “Process and Apparatus for Separating Particles of a Certain Order of Magnitude From a Suspension,” filed Sep. 15, 2016, which claims priority from EP15185912.1, filed Sep. 18, 2015, the disclosure of which is incorporated herein by reference.

### FIELD OF THE TECHNOLOGY

The disclosure relates to a process and an apparatus for separating a suspension C from a suspension A, wherein the fraction of particles P_{C} in the suspension C, which are smaller than a defined limit grain diameter, is greater than in the suspension A by at least the factor of 2, wherein the suspension A is introduced into a container extending from the bottom to the top and wherein a suspension B is withdrawn from the container, whose fraction of particles with a diameter greater than the defined limit grain diameter is increased with respect to suspension A.

### BACKGROUND

Suspension is understood to be a heterogeneous substance mixture of a liquid and solids finely dispersed therein. When a suspension is allowed to stand in a container, the solids slowly sink to the bottom and form a sediment when the solids have a greater density as compared to the pure liquid. The supernatant liquid is decanted and the solids thus can be separated from the liquid. The smaller a particle the smaller its density difference to the liquid, and the higher the viscosity of the liquid the more slowly the sedimentation proceeds. Shape and structure of the particles also influence the sedimentation. The sedimentation can be accelerated by centrifuges.

Substance properties of a suspension, above all the particle size and the distribution of the particle size, can be determined e.g. by an ultrasonic attenuation spectroscopy. In this process an ultrasonic wave runs through the suspension, wherein the intensity of this wave is attenuated. The amount of the attenuation is dependent on substance properties, the concentration of the particles and the size of the suspended particles. By connections and dependencies, in particular by corresponding calibration, distributions of particles in heterogeneous systems can be determined. What is difficult, however, is the targeted separation of particles of a certain size.

A separation of particles of different mean diameters can be achieved in principle in so-called rising chambers. As described for example in DD 293 065, a gas for this purpose is introduced into a solid bed from below, wherein the flow velocity of the gas is adjusted such that it entrains particles up to a certain size, while other particles exclusively are slightly fluidized or not lifted at all. By varying the gas velocity, particles of different diameters thus can be separated. Varying separation quantities can be achieved by using several rising chambers which are separately approached by gas from below.

U.S. Pat. No. 8,603,343 B2 describes a process for the separation of particles from a suspension, in which the separation of particles and a clear liquid is achieved by a special arrangement in a decanter.

### SUMMARY

It now is the object of the present disclosure to separate particles, in particular of the same density, of a certain order of magnitude from a suspension. In particular, there should be found a process and an apparatus which also allows to process suspensions in which gas mixtures or gas-suspension mixtures are present.

This object is solved by a process with the features according to the disclosure. For this purpose, a suspension A is introduced into a container extending vertically from the bottom to the top. To the top in the sense of the disclosure means that the bottom of the container is formed such that it has the shortest distance to the earth's surface, whereas all further parts, the side walls, lid, etc. are further away from the earth's surface. The bottom can be flat, but also be chosen with an inclination or formed rounded.

From this container, a suspension B, which is characterized in that it has a particle fraction P_{B} with a certain first mean particle diameter, is discharged via a discharge conduit. The particles P_{B} for at least 80 wt-%, for at least 90 wt-%, or for at least 95 wt-% contain particles whose diameter is larger than a defined limit grain diameter.

According to the disclosure, a suspension C is withdrawn via a discharge conduit in a second partial stream, which is characterized in that the fraction of particles which are smaller than a defined limit grain diameter is greater than in the suspension A by at least the factor of 2, by at least the factor of 5, or by at least the factor of 10. This partial stream is withdrawn above the first partial stream (suspension B).

Fraction in the sense of the disclosure is understood to be the weight of the specific particles in relation to the weight of all particles. The fraction P_{C} in the suspension C therefore is the total weight of all particles with a diameter smaller than the defined limit grain diameter divided by the total weight of all particles contained in the suspension C.

By withdrawing the second partial stream (suspension C) above the first partial stream (suspension B) through the discharge conduit, a flow is obtained within the container. At the same time, the force of gravity acts on all particles contained in the suspension, whereby the same move towards the bottom at a sinking velocity which is dependent on the respective particle mass and hence the individual particle diameter. Favorably, the flow resulting from the withdrawal of the suspension C vectorially is directed differently with respect to the direction of action of the gravitation. The larger particles, which due to their weight and hence also their larger particle diameter sink to the bottom, thus separate from those particles in which the sinking velocity is smaller than the flow velocity. Since here the different sinking velocity of the particles in the suspension in dependence on the diameter is utilized and particles sinking down very slowly are withdrawn by a flow, small particles can be separated from larger ones. By varying the discharge flow for the suspension C, particles with different properties can be withdrawn.

In particular, the particles themselves have a comparable density and a comparable material composition, respectively. By the process according to the disclosure, a size-dependent separation thus can be made. In principle, however, it also is conceivable to use this process for separating particles with the same size, but different density, from each other, wherein these density differences for example can result from different material compositions.

In this process, it is particularly favorable that other than in usual sedimentations the process can be carried out continuously, so that introduction and withdrawal of the suspensions is effected such that the filling quantity of the container remains approximately constant.

In particular, the disclosure is suitable for liberating suspended catalysts from fine grain whose defined limit grain diameter has a value between 10 and 50 μm, or between 15 and 30 μm.

In some embodiments, the stream fed into the container as suspension A has a solids concentration of 1 to 60 wt-%, such as 20 to 50 wt-%.

The disclosure in particular also is suitable for removing particles of a certain size from a gas-suspension mixture. In some embodiments, the gas dispersed in the suspension therefore is separated in the container by outgassing, which in the most simple form is accomplished in that the filling level in the contains is adjusted such that above the filling level a gas layer is present, into which the gas can outgas. Outgassing is positively influenced by the suspension not standing completely in the container.

In some embodiments, a pressure of more than 10 bar, more than 20 bar or of 25 to 35 bar exists in the container. Hence, the use of this process also is quite suitable for higher process pressures in the chemical industry, whereas in centrifuges considerable safety measures are necessary in this pressure range due to the large kinetic energy of the fast rotating rotors. In addition, centrifuging under excess pressure technically is very complex and therefore involves high costs.

In some embodiments, suspension A flows into the container due to a hydrostatic pressure gradient, which means that the apparatus can be arranged such that the pressure difference between the point of withdrawal of suspension stream A and the point of feedback of suspension B has an amount which effects a sufficient flow through the apparatus, but does not lead to an avoidable abrasion at the technical equipment or the flowing particles. When withdrawal and feedback take place from and into the same container, this driving force can be adjusted by the vertical distance between the points of withdrawal and feedback. A suitable throttle which is installed into the supply conduit of the suspension A and/or the discharge conduit of the suspension B likewise can positively influence the flow velocity of the suspension and the filling level in the apparatus, but is not required in principle for the disclosure.

On the other hand, it also is conceivable to pump in suspension A, so as to achieve a greater flexibility with regard to the arrangement of the entire plant.

The disclosure furthermore also comprises an apparatus for separating particles of a certain mean diameter from a suspension A with the features of various embodiments. Such apparatus comprises a container, at least one feed conduit for the suspension A into the container, and at least one outlet for a suspension B with a particle fraction P_{B}, in which at least 80 wt-%, at least 90 wt-%, or at least 95 wt-% of the particles have a diameter which is greater than a defined limit grain diameter. According to the disclosure, such apparatus also includes a discharge conduit for a suspension C which contains a particle fraction P_{C}, in which the weight fraction of particles which are smaller than a defined limit grain diameter is greater than in the suspension A by at least the factor of 2, by at least the factor of 5, or by at least the factor of 10.

This discharge conduit leads to a connected equipment, such as a container, in which a pressure exists which is smaller than the pressure in the apparatus. This pressure gradient can be the driving force for the flow. Alternatively, this flow also can be produced by a pump or by another method for increasing the pressure in the apparatus or for decreasing the pressure in the connected equipment. The flow velocity of the suspension C in the apparatus thus generated is greater than the sinking velocity of the particles P c contained therein.

In some embodiments, the container in its total height extends from the bottom to the top, wherein the outlet for the suspension B as measured from the bottom or the lowest point of the container maximally is arranged at a height of 20% of the total height. In some embodiments, the outlet for the suspension B is located at the lowest point of the container, so that all sunken particles can be removed from the container.

In some embodiments, the discharge conduit for the suspension C is located above the outlet for the suspension B. As a result, the particles not yet withdrawn can be separated by the resulting discharge flow, whereas larger and hence heavier particles sink to the bottom and hence leave the region of the container from which the suspension C is withdrawn.

Nevertheless, however, it also is conceivable to form the container with large width and provide the discharge conduit for suspension C opposite the supply conduit of suspension A. Via the path to be covered from the inlet to the outlet heavy particles then also would sink to the bottom, whereas light particles are discharged by the flow at the opposite outlet tube for the suspension C.

In some embodiments, the container includes at least one partition wall by which two chambers not completely separated from each other are obtained. In some embodiments, the feed conduit for suspension A opens into the first chamber and the discharge of suspension C is located in another chamber. It thereby is ensured that there is no flow short-circuit between feed and discharge conduit, but all particles remain in the system long enough, so that heavier particles can sink to the bottom.

It is particularly favorable when the chambers are open in the lower region. Lower region in the sense of the disclosure refers to the fact that the partition walls do not directly adjoin the bottom of the container. This is particularly favorable, as the particles thus forcibly sink down from the feed conduit due to the arrangement of the partition wall, wherein the heavier particles sink down completely and thus can be separated from the lighter particles discharged with the outgoing flow.

In some embodiments, the feed conduit opens into the first chamber in which entrained gas escapes from the suspension by outgassing and is discharged through a gas outlet.

An embodiment of the disclosure provides three chambers, so that two partition walls are present. The first chamber includes the supply conduit for the suspension A, whereas the two other chambers each include a discharge conduit for the suspension C. This has the advantage that by valves in the discharge conduits one of the separation chambers each can be excluded from the withdrawal, so that different quantities of suspension C can be withdrawn from the container without the flow velocity in the remaining separation chamber(s) and thus also the mean diameter of the withdrawn particles being changed.

In some embodiments, when the cross-sectional area of the second chamber relative to the cross-sectional area of the third chamber has a ratio which lies between 1:0.2 to 1:5 or is 1:2, wherein the cross-sectional area can extend parallel to the bottom. There are obtained three different possible withdrawal quantities, namely the withdrawal from the smaller chamber, the withdrawal from the larger chamber and the withdrawal from both chambers. This system also can be transferred to an even larger number of chambers.

What is also favorable is a conical bottom, as it prevents an actual settling of particles (sedimentation), in particular when the discharge conduit for the suspension B is provided at the lowest point of the bottom.

The disclosure also comprises the use of the apparatus for separating deactivated catalyst from a product stream of a Fischer-Tropsch synthesis. In a Fischer-Tropsch synthesis, synthesis gas which substantially is a mixture of hydrogen and carbon monoxide is converted to longer-chain hydrocarbon chains. This reaction for example is carried out in so-called bubble column reactors. The synthesis gas here is passed through a suspension of catalyst particles and hydrocarbons formed in the process, whereby a fluidization or slurry of the catalyst particles is caused. On the catalyst, a large part of the synthesis gas used is converted to the longer-chain hydrocarbons, wherein these hydrocarbons are present both in gaseous and in liquid form. After leaving the reactor, non-converted synthesis gas is separated from the gaseous product stream and again supplied to the reactor.

The metallic catalysts used for this process, substantially cobalt or iron, are applied onto the surface of carrier particles of e.g. aluminum oxides. In the following, these systems are referred to as catalyst particles. The catalyst particles are fluidized by the ascending bubbles and additional devices in the reactor and distributed within the reactor management such that a rather uniform catalyst concentration is present over the entire height and the cross-section of the reactor. Inevitably, mechanical loads of the catalyst particles also occur due to shocks of the particles among each other and by friction/collision of the particles with the internal fittings of the reactor, such as heat exchanger, device for gas distribution, devices for product separation, and others. Additional loads are produced by pressure fluctuations and evaporation of reaction products in the pores of the catalyst particles. In the long run, these mechanical loads produce catalyst fragments.

It has now been found that the mechanisms which lead to the mechanical degradation of the catalyst particles equally concern all particles. Hence, the actual size of the catalyst particles in relation to the mean size of the used catalyst particles is a measure of how long the respective catalyst particles have already been present in the system. The longer the individual catalyst particles have been used already, the smaller they are, since they were exposed to the load in the system for a correspondingly longer time. The finest particles thus are those particles which are subject to most of the degradations and thus have been in the reactor for the longest time. Due to this long use, the smallest particles hence also have the least chemical activity. The removal of the finest and oldest particles and the replacement of the removed catalyst by fresh catalyst hence serves the maintenance of the reactivity of the reaction mixture.

Thus, the idea underlying the disclosure also consists in separating the small particles continuously or at regular intervals and thus in removing inactive catalyst from the system. New, active catalyst then likewise must be filled up. A uniform catalyst activity of the plant hence can be ensured. In the ideal case it even is possible to completely avoid downtimes for the exchange of catalyst and to operate the plant over many years with a continuously exchanged catalyst. The reactivity of the mixture of hydrocarbons and catalyst in the described reactor thus is maintained in commercial operation.

In Fischer-Tropsch reactions, the catalyst fraction discharged with the product so far usually is isolated and discarded or recirculated completely. A targeted withdrawal of mostly fine and/or deactivated particles does not occur.

Further features, advantages and possible applications of the disclosure can also be taken from the following description of the drawing. All features described and/or illustrated form the subject-matter of the disclosure per se or in any combination.

Various embodiments provide a process for the separation of a suspension C from a suspension A, wherein the fraction of particles P_{C} in the suspension C, which have a diameter smaller than a defined limit grain diameter, is greater than in the suspension A by at least the factor of 2, wherein the suspension A is introduced into a container extending from the bottom to the top and wherein a suspension B is withdrawn from the container, whose fraction of particles with a diameter greater than the defined limit grain diameter is increased with respect to suspension A, wherein the suspension C is withdrawn from the container in a second partial stream above the first partial stream due to the fact that the flow velocity of the suspension C is greater than the sinking velocity of the particles P c contained therein.

In various embodiments, the process is carried out continuously and with stationary operating conditions.

In various embodiments, the defined limit grain diameter has a value between 10 and 50 μm.

In various embodiments, the suspension A contains a gas.

In various embodiments, the gas in the container is separated by outgassing and subsequently is withdrawn.

In various embodiments, a pressure of more than 10 bar exists in the container.

In various embodiments, suspension A flows into the container due to an applied or a hydrodynamic flow.

Various embodiments provide an apparatus for separating a suspension C from a suspension A, wherein the weight percentage of particles P_{C} in the suspension, which are smaller than a defined limit grain diameter, is greater than in the suspension A by at least the factor of 2, comprising a container, at least one feed conduit for the suspension A into the container and at least one outlet for a suspension B, whose fraction of particles with a diameter greater than the defined limit grain diameter is increased with respect to suspension A, characterized in that a discharge conduit is provided for a suspension C, wherein by at least one device a flow is applied such that the flow velocity of the suspension C is greater than the sinking velocity of the particles P_{C} contained therein, and wherein at least one discharge conduit for the suspension C is arranged above the outlet for the suspension B.

In various embodiments, the container with its entire height cylindrically extends from its bottom to the top.

In various embodiments, by at least one partition wall the container is divided into at least two chambers not completely separated from each other.

In various embodiments, the chambers are open in the lower region.

In various embodiments, the feed conduit opens into the first chamber in which gas escapes from the suspension by outgassing and can be withdrawn through a conduit and that at least one discharge conduit is provided for the suspension C in the region of at least one other chamber.

In various embodiments, three chambers are provided, wherein into one chamber the feed conduit for the suspension A opens and into the two other chambers discharge conduits for the suspension C are provided.

In various embodiments, the horizontal cross-sectional area of the second chamber relative to the horizontal cross-sectional area of the third chamber has a ratio of 2:3.

Various embodiments provide use of the apparatus according to the disclosure for separating catalyst fine grain from a product stream of a Fischer-Tropsch synthesis.

Various embodiments provide use of the apparatus according to the disclosure for separating deactivated catalyst from a product stream of a Fischer-Tropsch synthesis.

### BRIEF DESCRIPTION OF THE DRAWINGS

In the drawing:

FIG. 1 shows a schematic representation of a plant according to the disclosure,

FIG. 2 shows a schematic representation of a Fischer-Tropsch process according to the prior art, and

FIG. 3 shows a schematic representation of a Fischer-Tropsch process according to the disclosure.

### DETAILED DESCRIPTION

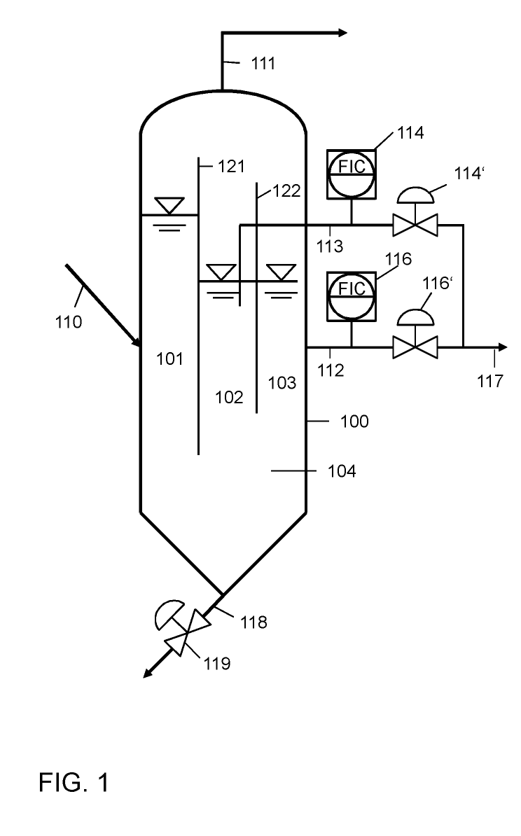

FIG. 1 schematically shows the apparatus according to the disclosure for separating fine particles from the entire stream.

The container 100 used here includes a feed conduit 110 via which a suspension A is introduced into the container. Through the partition walls 121 and 122, which do not extend down to the bottom, three chambers 101, 102 and 103 are obtained, wherein the feed conduit 110 opens into the chamber 101.

Process gas possibly contained in the suspension A here exits via the indicated surface of the suspension and can be discharged via conduit 111. The remaining suspension is backed up. Both downstream chambers 102 and 103 have two different sizes in which the ratio of the cross-sectional area of the chamber 102 relative to the cross-sectional area of the chamber 103 is 1:2.

Via the conduits 112 and 113, the suspension C which contains the particles P_{C}, in which the weight percentage of particles which are smaller than a defined limit grain diameter is greater than in the suspension A by at least the factor of 2, can be withdrawn from the chambers 102 and 103. The flow rate of suspension C can be controlled via the control device 114 and the associated valve 114′ or via the control device 116 and the associated valve 116′. Via the withdrawal of the stream of suspension C a flow velocity in the chambers 102 and 103 can be applied. With increasing particle size the sinking velocity of particles increases. When the sinking velocity of the particle is greater than the flow velocity in the separation chambers 102 and 103, the particle is discharged via conduit 118 as suspension B which contains the particles P_{B} by using the control device 119, in which suspension at least 80 wt-% of the particles have a diameter which is greater than a defined limit grain diameter. When the particle, however, is smaller and its sinking velocity therefore is smaller than the flow velocity obtained in the separation chambers 102 and 103 through the discharge conduits 112 and 113, the particle is discharged there via conduit 112 or 113.

With the selection of the used chambers for separation, namely only the smaller chamber, only the larger chamber or both chambers in parallel, the quantity of the discharged suspension can be varied without the flow velocity in the chamber and hence the size of the discharged particles being changed thereby. The constructional determination of the cross-sectional area for the chambers is effected corresponding to the targeted limit grain size, i.e. that particle size which is to be discharged. Further factors to be considered here are the density differences between the solids and the surrounding liquid.

According to the disclosure, the disclosed process proceeds with particular separation sharpness when a constant level of the liquid is ensured in the two chambers 102 and 103. This is the only way to ensure that the particles in the chambers 102 and 103 must pass a sufficiently quiet zone and thus sinking velocity and flow velocity actually compete with each other and there is no discharge of larger particles at individual points due to locally larger flow velocities.

According to the disclosure, the process can be operated both continuously and alternately. It can also be advantageous to multiply such plant, to use reactors operated in parallel for generating the suspension A, so that the apparatus according to the disclosure alternately is charged by several reactors. In principle, it also is conceivable that several streams jointly enter into the apparatus according to the disclosure.

It also can be expedient to control the pressure in the container by supplying nitrogen. This nitrogen, which for example can originate from a waste gas treatment, can then be discharged again via conduit 111.

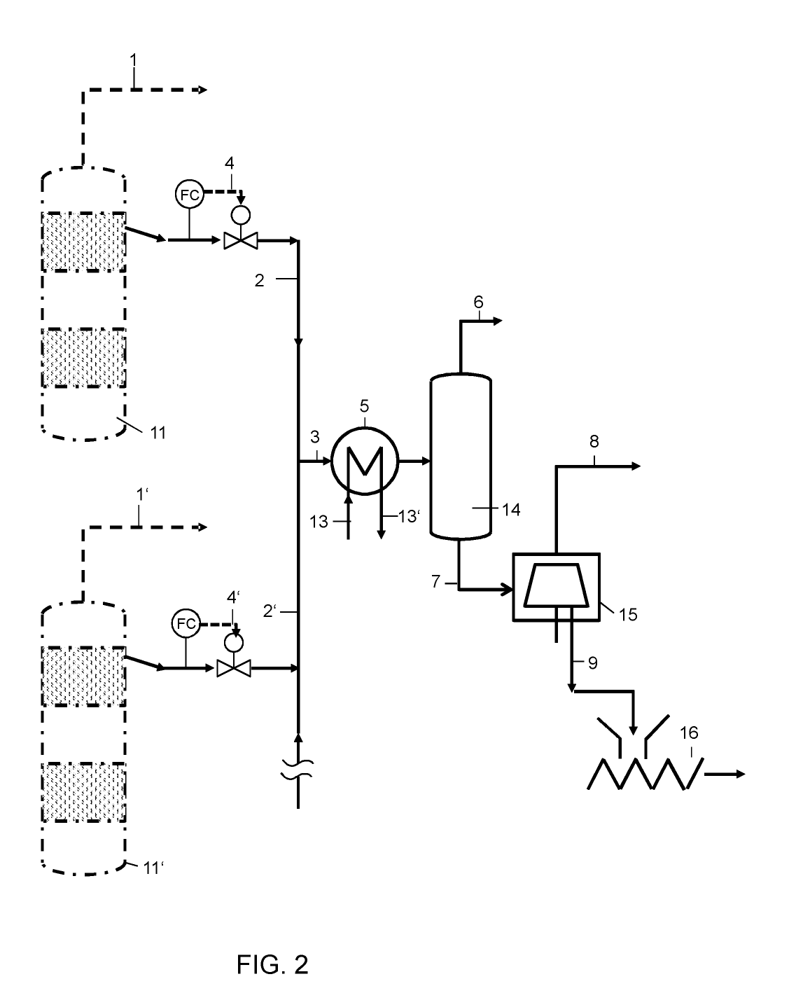

FIG. 2 shows the integration of a plant known from the prior art in a Fischer-Tropsch synthesis.

From the two bubble column reactors 11 and 11′ connected in parallel a continuous process stream is withdrawn and discharged via the conduits 2 and 2′. The withdrawal of this stream can be metered via the control device 4 and 4′, respectively. The conduits 2 and 2′ then open into conduit 3, via which the collected stream is guided into a heat exchanger 5 and into a storage tank 14.

The heat exchanger medium is supplied and discharged again via the conduit 13, 13′. In the storage tank 14, the pressure is controlled in a waste gas treatment by supplying nitrogen with elevated pressure and possibly by discharging nitrogen via conduit 6.

Via conduit 7, the suspension is supplied from the storage tank to a centrifuge 15 for separating the contained solids.

The light phase separated there is supplied to the treatment of the contained Fischer-Tropsch products by means of conduit 8. The light phase is supplied to a cooling device 16 via conduit 9. The suspension subsequently can be disposed of or be reprocessed in a non-illustrated way.

For a process management according to FIG. 2, Table 1 shows specific parameters of individual streams which are divided onto the two reactors 11 and 11′ and each have a total mass flow of 3565 kg/h each. Particles with a grain size of 25 μm are removed.

TABLE 1
Stream composition with a process design acc. to FIG. 2.

| | 2, 2′ | 3 | 7 | 9 | 8 |
|---|---|---|---|---|---|
| Mass flow of all | 1069.6 | 7130 | 7130 | 4750 | 2380 |
| particles (kg/h) | | | | | |
| Temperature (° C.) | 234 | 234 | 150 | 148 | 148 |
| Pressure (bar(g)) | 10 | 10 | 9.5 | 0.2 | 0.2 |
| Mass flow of the | 38.5 | 77 | 77 | 75.9 | 1.1 |
| particles below the | | | | | |
| limit grain size (kg/h) | | | | | |
| Mass flow of the | 1031 | 2062 | 2062 | 2061.9 | 0.1 |
| particles above the | | | | | |
| limit grain size (kg/h) | | | | | |

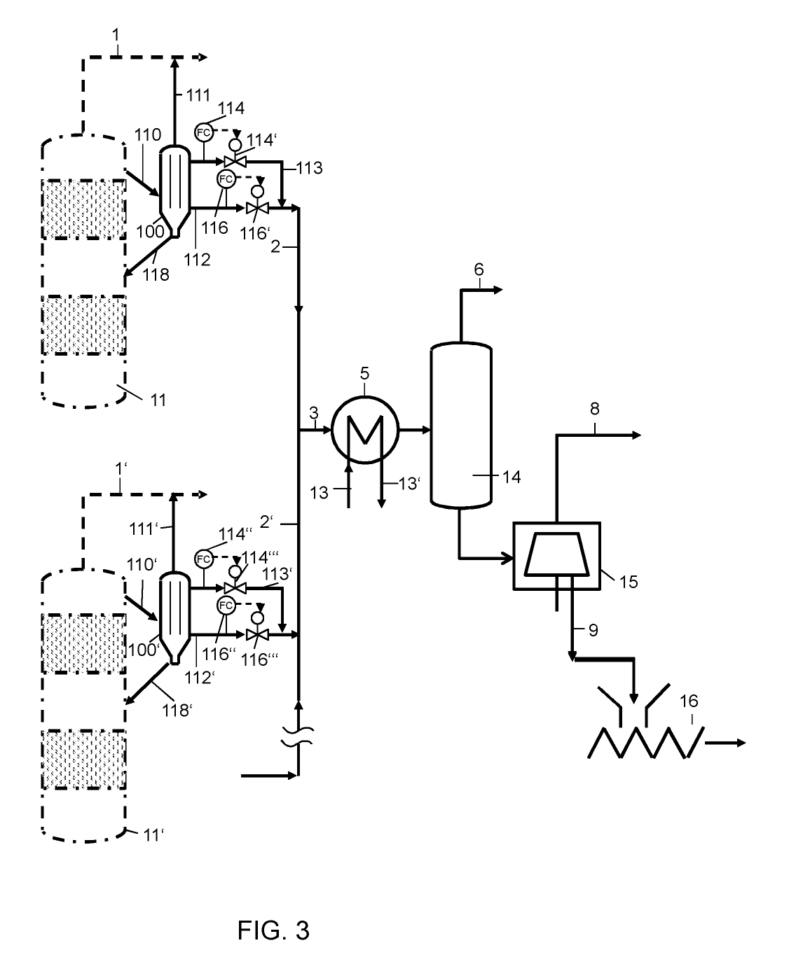

FIG. 3 shows the integration of an apparatus according to the disclosure in a Fischer-Tropsch synthesis. The gaseous products obtained again are largely discharged from the bubble column reactors 11 and 11′ via conduits 1 and 1′.

Via conduits 110 and 110′, a continuous product stream which contains liquid hydrocarbons, catalyst particles and in part also gaseous hydrocarbons is withdrawn and supplied to the container 100 and 100′, respectively. This container 100, 100′ is designed as shown in FIG. 1.

In the container 100 and 100′ the gas contained in the inflowing product initially is separated and via conduits 111 and 111′ combined with the waste gas from the bubble column reactor 11, 11′ in conduit 1, 1′ and discharged.

Via conduits 118 and 118′, in which a non-illustrated control device 119, 119′ is provided, the suspension B, which contains a particle fraction P_{B} in which at least 80 wt-% of the particles have a diameter which is greater than a defined limit grain diameter, gets back into the bubble reactor 11, 11′.

One or more partial streams with the suspension C, which contains a particle fraction P_{C} in which the weight percentage of particles which are smaller than a defined limit grain diameter is greater than in the suspension A by at least the factor of 2, are discharged from the container 100, 100′ in a controlled manner via conduit 112, 112′ and/or 113, 113′ and fed into the common conduit 3 via conduit 2, 2′. The further configuration corresponds to the one explained in FIG. 2.

Table 2 describes the stream composition for the incorporation of the disclosure in a Fischer-Tropsch process as shown in FIG. 3. A total mass flow of wax and particles of 53526 kg/h each is charged to the two reactors 11 and 11′, in order to remove particles with a grain size of 25 μm and smaller from the system.

TABLE 2
Stream composition with a process design acc. to FIG. 3.

| | 110, 110′ | 113 | 2 | 3 | 7 | 9 | 8 |
|---|---|---|---|---|---|---|---|
| Mass flow of all | 16058 | 3509 | 5168 | 10336 | 10336 | 331 | 10005 |
| particles (kg/h) | | | | | | | |
| Temperature (° C.) | 234 | 234 | 234 | 234 | 150 | 148 | 148 |
| Pressure (bar(g)) | 32 | 10 | 10 | 10 | 9.5 | 0.2 | 0.2 |
| Mass flow of the | 578 | 26.1 | 38.5 | 77 | 77 | 72.3 | 4.7 |
| particles below the | | | | | | | |
| limit grain size (kg/h) | | | | | | | |
| Mass flow of the | 15480 | 26.1 | 38.5 | 77 | 77 | 72.3 | 4.7 |
| particles above the | | | | | | | |
| limit grain size (kg/h) | | | | | | | |

### LIST OF REFERENCE NUMERALS

1-3 conduit
4, 4′ control device
5 heat exchanger
6-9 conduit
11, 11′ bubble column reactor
13 conduit
15 storage tank
15 centrifuge
16 cooling device
100, 100′ container
101-103 chamber
104 lower region
110-113′ conduit
114-114′″ control device
116-116′″ control device
117, 118 conduit
119 control device
121, 122 partition wall

1. A process for the separation of a suspension C from a suspension A, wherein the fraction of particles P_{C} in the suspension C, which have a diameter smaller than a defined limit grain diameter, is greater than in the suspension A by at least the factor of 2, wherein the suspension A is introduced into a container extending from the bottom to the top and wherein a suspension B is withdrawn from the container, whose fraction of particles with a diameter greater than the defined limit grain diameter is increased with respect to suspension A, wherein the suspension C is withdrawn from the container in a second partial stream above the first partial stream due to the fact that the flow velocity of the suspension C is greater than the sinking velocity of the particles P_{C} contained therein.

2. The process according to claim 1, wherein the process is carried out continuously and with stationary operating conditions.

3. The process according to claim 1, wherein the defined limit grain diameter has a value between 10 and 50 μm.

4. The process according to claim 1, wherein the suspension A contains a gas.

5. The process according to claim 4, wherein the gas in the container is separated by outgassing and subsequently is withdrawn.

6. The process according to claim 1, wherein a pressure of more than 10 bar exists in the container.

7. The process according to claim 1, wherein suspension A flows into the container due to an applied or a hydrodynamic flow.

8. An apparatus for separating a suspension C from a suspension A, wherein the weight percentage of particles P_{C} in the suspension, which are smaller than a defined limit grain diameter, is greater than in the suspension A by at least the factor of 2, comprising a container, at least one feed conduit for the suspension A into the container and at least one outlet for a suspension B, whose fraction of particles with a diameter greater than the defined limit grain diameter is increased with respect to suspension A, wherein a discharge conduit is provided for a suspension C, wherein by at least one device a flow is applied such that the flow velocity of the suspension C is greater than the sinking velocity of the particles P_{C} contained therein, and wherein at least one discharge conduit for the suspension C is arranged above the outlet for the suspension B.

9. The apparatus according to claim 8, wherein the container with its entire height cylindrically extends from its bottom to the top.

10. The apparatus according to claim 8, wherein by at least one partition wall the container is divided into at least two chambers not completely separated from each other.

11. The apparatus according to claim 10, wherein the chambers are open in the lower region.

12. The apparatus according to claim 10, wherein the feed conduit opens into the first chamber in which gas escapes from the suspension by outgassing and can be withdrawn through a conduit and that at least one discharge conduit is provided for the suspension C in the region of at least one other chamber.

13. The apparatus according to claim 10, further comprising three chambers, wherein into one chamber of the three chambers the feed conduit for the suspension A opens and into the two other chambers of the three chambers discharge conduits for the suspension C are provided.

14. The apparatus according to claim 13, wherein the horizontal cross-sectional area of the second chamber relative to the horizontal cross-sectional area of the third chamber has a ratio of 2:3.

15. A use of the apparatus according to claim 8 for separating catalyst fine grain from a product stream of a Fischer-Tropsch synthesis.

16. A use of the apparatus according to claim 8 for separating deactivated catalyst from a product stream of a Fischer-Tropsch synthesis.
